(19) United States
(12) Patent Application Publication
(10) Pub. No.: US 2002/0020771 A1
(43) Pub. Date: Feb. 21, 2002

(54) Comminution assembly

(76) Inventor: Peter E. Hayles JR., Toms River, NJ (US)

Correspondence Address: Clifford G. Frayne, Suite 7A, 136 Drum Point Road, Brick, NJ, 08723, US

(21) Appl. No.: 09/912,625

(22) Filed: Jul. 26, 2001

Related U.S. Application Data
(60) Provisional application No. 60/225,578, filed on Aug. 16, 2000.

(51) Int. Cl. B02C 7/12

(52) U.S. Cl. 241/261.2

(57) ABSTRACT

There is disclosed a comminution assembly for effecting particle size reductions in a liquid slurry, the assembly having paired interconnecting cylindrical chambers wherein each chamber is provided with a rotatable shaft having a rotatable disk mounted thereon wherein each disk is comprised of a donut-shaped planar upper surface and a donut-shaped planar lower surface there being disposed between said surfaces a plurality of vanes so as to direct and impel a slurry containing the size reduction particulate matter to the point of interconnection of the cylindrical chambers whereby the particulate matter from the opposing disk members impinge upon each other to effectuate particle size reduction.

### BACKGROUND OF THE INVENTION

1. Field of the Invention

The present invention relates to a device for reducing particle size, achieving particle size uniformity and for uniformly disbursing solids within a liquid slurry to produce a homogeneous product having particular application to low viscosity slurries.

### RELATED APPLICATIONS

This application claims the benefit of provisional application 60/225,578, filed Aug. 16, 2000.

2. Description of the Prior Art

A large number of manufacturing processes call for the uniform dispersion of dissimilar materials to produce a homogeneous slurry product. Often, the starting materials are irregular size, and must be reduced to a uniform size, such as a very fine powder, which must then be uniformly dispersed within a solvent carrier to produce a master batch of material. This is particularly true in paints and printing inks.

Certain of the prior art devices which have attempted to carry out this process have utilized mechanical means in which metal to metal surfaces were used to attempt to crush the solid particles to achieve a uniform size for dispersion or alternatively, prior machines would use sand, shot, ceramic beads or stones in an effort to reduce particle size by having a plurality of these elements interacting with the materials in order to attempt to obtain a uniform particle size for uniform dispersion. These prior art devices were limited by the characteristics and viscosity of the solvent carrier. Additionally, these prior art machines tended to produce accelerated wear on the equipment due to their abrasive nature of operation.

None of the prior art devices have been successful in repeatedly reducing particle size, obtaining a uniform particle size and producing a uniform dispersion in either a low or high viscous slurry of the type encountered with paints, lacquers and inks without causing accelerated deterioration on the equipment as a result of the abrasive nature. The prior art devices were particularly deficient when dealing with a low viscosity slurry for which the present invention is particularly adapted.

### OBJECTS OF THE INVENTION

An object of the present invention is to provide for a novel comminution assembly for particle size reduction of low or high viscosity slurries without the addition of solid media such as sand, grit, shot or ceramic balls.

Another object of the invention is to provide for a novel comminution assembly which does not rely upon mechanical means for obtaining a particle size reduction.

Still another object of the present invention is to provide for a novel mixing assembly which utilizes the slurry particles themselves and opposing bombardment, to obtain particle size reduction.

A still further object of the present invention is to provide for a novel comminution assembly which will provide for more uniform particle size and more uniform dispersion of particles in a solvent carrier so as to provide for a homogeneous product.

### SUMMARY OF THE INVENTION

The comminution assembly is formed with two disks with internal directional vanes, positioned in opposition to each other in a housing cavity. Each disk has an inlet tube attached to its center and the liquid and particulate to be reduced in size is pumped into the inlet tube and then flows outwardly under the influence of the spinning disks and directional vanes. The fluid and particles are accelerated toward the outer edge of the disks at approximately equal speeds and at opposing angles. The particles exit the vanes of the spinning disk at the same velocity as the outer edge of the spinning disk. The result is that the particles impact upon one another at double the speed of either the initial stream velocities causing particle collisions resulting in the fracture of the particles leading to particle size reduction. The slurry, including the pigment, fillers or the like and the carrier can be reintroduced into the mixing assembly as many times as necessary in order to achieve the desired particle size and particle size dispersion.

### BRIEF DESCRIPTION OF THE DRAWINGS

A better understanding of the invention will be discerned when considering the following figures wherein:

FIG. 1 is a side view of the mixing assembly of the present invention in an on line configuration.

FIG. 2 is a cross section view of the mixing assembly view along plane 2-2 of FIG. 1 of the present invention.

FIG. 3 is a side view of the mixing disk.

FIG. 4 is a cross section view of the mixing disk along plane 4-4 of FIG. 3.

FIG. 5 is a cross section view of the mixing disk along plane 5-5 of FIG. 3.

FIG. 6 is a cross section view of the mixing assembly along plane 6-6 of FIG. 1, plane 6-6 being in the same plane as plane 5-5 of FIG. 3.

### DETAILED DESCRIPTION OF THE DRAWINGS

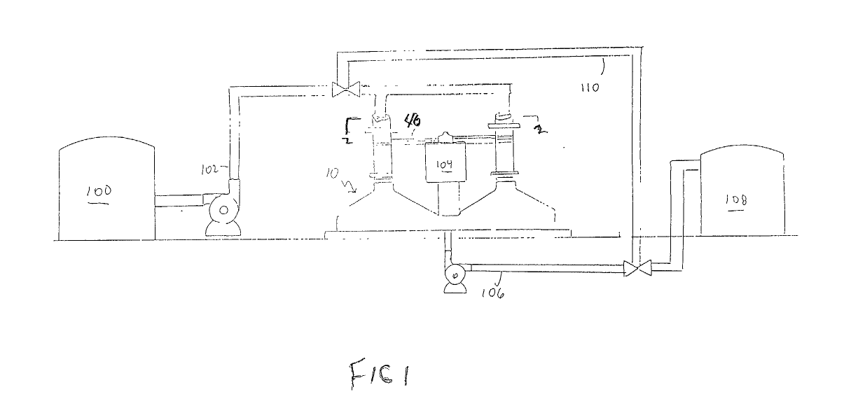

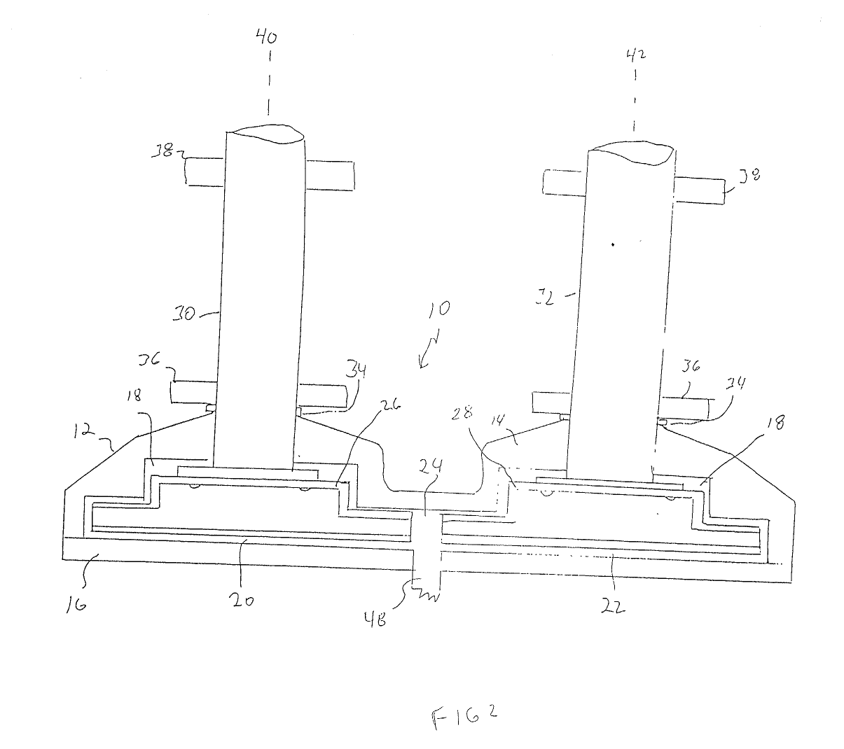

FIG. 1 is a side view of the comminution assembly 10 of the present invention in an on line operational configuration. A source of particulate matter to be reduced and dispersed, together with its liquid carrier is transported from a storage vessel 100 via conduit means 102 for introduction into mixing assembly 10. Mixing assembly 10 is operated by a motor 104 which imparts rotational energy to the inlet conduits and mixing disks contained within the mixing assembly 10 as more fully described hereafter. The slurry containing the particulate matter and liquid carrier exits via conduit 106 and may either be directed to a storage completion tank 108 or may be reintroduced into the mixing assembly 10 by conduit means 110 to further effect particle reduction and dispersion. A better understanding of the mixing assembly 10 will be had with reference to FIG. 2 which is a cutaway side view of the mixing assembly along plane 2-2 of FIG. 1.

The mixing assembly 10 comprises a housing 12 defined by an upper member 14 and a lower member 16, which when secured together form housing 12 and define a mixing chamber 18. Mixing chamber 18 is comprised of two complimentary chambers 20 and 22 preferably circular in cross section and in tangential communication with each other at the central portion 24 of the housing member 12. Chambers 20 and 22 are for receipt of mixing disks 26 and 28 which will be more fully described hereafter. Secured to mixing disks 26 and 28 are inlet tubes 30 and 32. Inlet tubes 30 and 32 extend through upper member 14 and suitable sealing member 34 is positioned between the inlet tubes 30 and 32 and the upper member 14 of housing 10. Suitable bearings 36 and 38 are affixed to the inlet tubes 30 and 32 in that the respective inlet tube and the disk member 26 or 28 rotate about their axis 40 and 42 in unison in response to a motor means 104 and rotational transfer means 46, such as a belt, chain or gearing mechanism. An outlet conduit 48 would be in communication with chamber 18 and conduit 106.

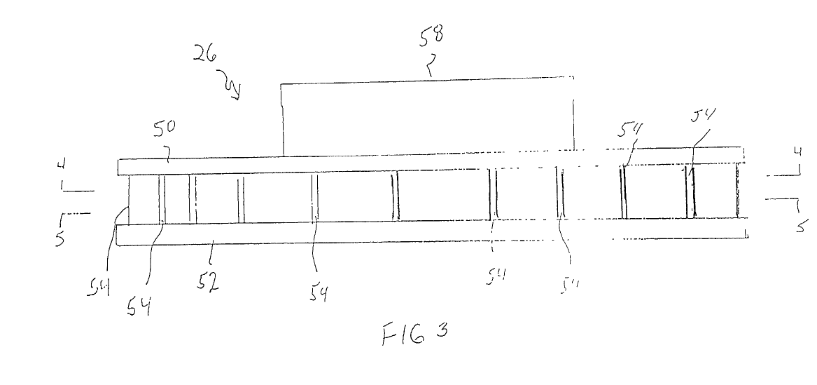

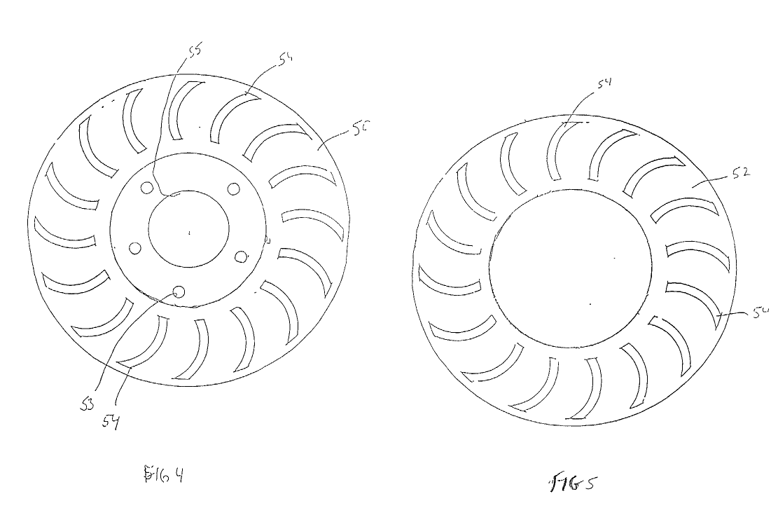

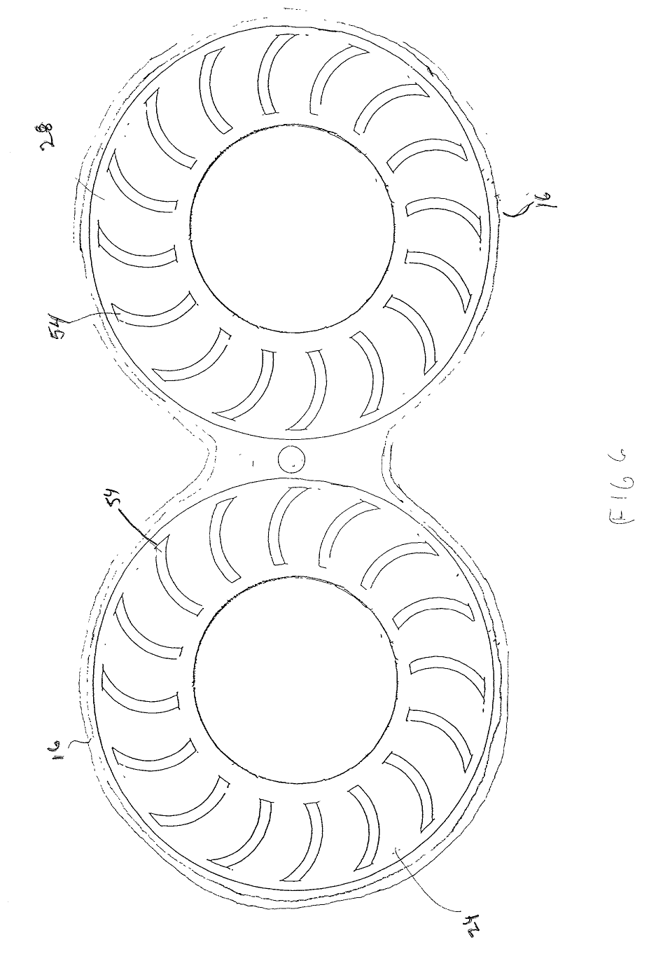

Mixing disks 26 and 28 are best understood with reference to FIG. 3 which is a side view of mixing disk 26, FIG. 4 which is a planar view along plane 4-4 of FIG. 3, and FIG. 5 which is a planar view along plane 5-5 of FIG. 3. Referring to FIG. 3, a side view of disk 26, there is illustrated an upper planar circular disk wall 50 and a lower circular planar disk wall 52. Upper and lower disk walls 50 and 52 are preferably donut-shaped and spaced apart for the positioning therebetween of a plurality of arcuate vanes 54 which are secured to upper and lower disk member 50 and 52. Extending upwardly from upper disk member 50 is an attachment member 58 which may be integrally formed with upper disk member 50.

Attachment member 58 comprises a cylindrical side wall and a planar donut-shape top wall having a plurality of apertures therethrough for fastening means for securing mixing disk member 26 to inlet tube 30. A central aperture 55 cooperates with inlet conduit 30 for introduction of slurry into mixing chamber 18. Mixing disk 28 is of identical construction as mixing disk 26 described above.

FIG. 6 is a cross section view of the mixing assembly 10 along plane 6-6 of FIG. 1. Plane 6-6 of FIG. 1 corresponds to plane 5-5 of FIG. 3. This view illustrates the positioning of the mixing disks 26 and 28 within lower member 16 of housing 12 and further illustrates the central portion 24 of housing member 12 between chambers 20 and 22 of mixing chamber 18 where the slurry exiting mixing disk 26 is directed at the slurry exiting mixing disk 28 causing the solid particulate in the slurry to impinge upon itself and thus reduce particle size and improve particle size dispersion. FIG. 6 further illustrates the preferential positioning of outlet conduit 48 and central area 24 for removal of the slurry matter for either recycle for further particulate size reduction and dispersion or for other processing requirements.

Housing 12 is able to be disassembled to allow the mixing disks 26 and 28 to be positioned within complimentary chambers 20 and 22 of housing 12. Housing 12 would then have its upper member 14 and lower members secured and inlet conduits 30 and 32 would be adjusted on bearings 36 and 38 so that there would be the proper clearance between the mixing disks 26 and 28 and the interior walls of mixing chamber 18. The preferable clearance would be 0.125 inches.

In operation, a slurry of liquid and particulate would be introduced from a storage source 100 into inlet conduits 30 and 32. The slurry would flow downwardly in inlet conduits 30 and 32 and fill the mixing chamber 18 such that the slurry flowed about the clearance between the mixing disks 26 and 28 and the interior walls of chamber 18 and also flowed within the mixing disks 26 and 28 and outwardly through the passageways defined by the vanes 54 on mixing disks 26 and 28. The slurry would exit the mixing chamber by means of outlet conduit 48. During such steady state conditions, inlet conduits 30 and 32 and their respective mixing disks 26 and 28 are rotated at preselected revolutions per minute. The slurry introduced into the interior of the mixing disks 26 and 28 is accelerated centrifugally outwardly by the rotating motion of the mixing disk and vanes 54 such that the slurry exiting mixing disk 26 is directed at the slurry exiting mixing disk 28 at the central portion 24 of the mixing chamber 18 causing the solid particulate matter in the slurry to impinge upon itself thus reducing particle size and improving particle reduction, therefore aiding in dispersion.

The exiting slurry can be recycled for reintroduction into the mixing apparatus 10 for any number of passes therethrough until the desired particle size reduction and particle dispersion is obtained.

For purposes of illustration, the various elements of the mixing assembly have been positioned and identified in the drawings in one embodiment of their relationship. It will be recognized by those having skill in the art, that different conduit arrangements and mechanical arrangements can be made without departing from the spirit and scope of the invention.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A comminution assembly for reducing particle size, achieving particle size uniformity, and for uniformly disbursing solids within a liquid slurry to produce a homogeneous product, the comminution assembly comprising:
a housing member having interconnecting, cylindrically-shaped chambers;
a shaft rotatably disposed in each of said chambers, said shafts being parallelledly disposed to one another;
a disk member mounted on each of said shafts transverse to the longitudinal axis of each chamber, said discs comprising a planar donut-shaped upper surface and a planar donut-shaped lower surface, there being disposed between said upper and lower surfaces, a plurality of fixed vanes extending to the perimeter of said disks, said vanes defining a plurality of passageways from a centrally disposed aperture in said disk member;
an inlet conduit means disposed within each of said shafts for introducing a liquid slurry having size reduction particulate material into said housing and into said centrally disposed aperture of said disk member;
an outlet means for removing size reduced particulate material from said housing; and
means for rotating said shafts at a speed to cause said side reduction particulate material to flow outwardly from said disk members directed by said vane members to cause a respective flow from one disk to contact a respective flow from said opposing disk effecting particle/particle contact to affect particle size reduction at a point of said interconnecting, cylindrically-shaped chambers.

2. The comminution assembly in accordance with claim 1 wherein said vanes on said disks are arcuate in shape so as to impel and direct said size reduction particulate material.

3. The comminution assembly in accordance with claim 1 wherein said disk members rotate in opposing directions.

4. The comminution assembly in accordance with claim 1 wherein said housing is such that said liquid slurry introduced flows through said passageways.

5. The comminution assembly in accordance with claim 1 wherein said assembly provides means for recirculating said size reduced particulate material for further size reduction.

6. The comminution assembly in accordance with claim 1 wherein the assembly is particularly effective in processing low viscosity slurries.
